(19) United States
(12) Patent Application Publication
(10) Pub. No.: US 2011/0292823 A1
(43) Pub. Date: Dec. 1, 2011

(54) SOUNDING REFERENCE SIGNAL (SRS) IN HETEROGENEOUS NETWORK (HETNET) WITH TIME DIVISION MULTIPLEXING (TDM) PARTITIONING

(75) Inventors: Alan Barbieri, San Diego, CA (US); Zhengwei Liu, San Diego, CA (US); Madhavan Srinivasan Vajapeyam, San Diego, CA (US); Hao Xu, San Diego, CA (US); Tingfang Ji, San Diego, CA (US)

(73) Assignee: QUALCOMM Incorporated, San Diego, CA (US)

(21) Appl. No.: 13/115,834

(22) Filed: May 25, 2011

Related U.S. Application Data
(60) Provisional application No. 61/349,083, filed on May 27, 2010.

(51) Int. Cl. H04W 72/04; H04W 24/00

(52) U.S. Cl. 370/252; 370/329

(57) ABSTRACT

Methods and apparatus for uplink (UL) radio link monitoring (RLM) in a Long Term Evolution (LTE) heterogeneous network (HetNet) with enhanced inter-cell interference coordination (eICIC) are described. Various options are presented in an effort to transmit a sounding reference signal (SRS) of a user equipment device (UE) served by a Node B in the HetNet, avoiding both interference from UL transmissions from other UEs being served by neighboring Node Bs and collisions with the UE's own channel quality information (CQI) or physical uplink shared channel (PUSCH), for example.

### CROSS-REFERENCE TO RELATED APPLICATIONS

This application claims benefit of U.S. Provisional Patent Application Ser. No. 61/349,083, entitled “SRS in HetNet with TDM Partitioning” and filed May 27, 2010, which is herein incorporated by reference.

### BACKGROUND

I. Field

Certain aspects of the present disclosure generally relate to wireless communications and, more specifically, to reducing interference when monitoring an uplink channel through cooperative partitioning of resources between a serving Node B and one or more non-serving Node Bs.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

In an aspect of the disclosure, a method for wireless communications is provided. The method generally includes determining, based on cooperative partitioning of resources between a serving Node B and one or more non-serving Node Bs, uplink (UL) resources for a user equipment (UE) to send a signal for monitoring a radio link; and transmitting an indication of the UL resources.

In an aspect of the disclosure, an apparatus for wireless communications is provided. The apparatus generally includes means for determining, based on cooperative partitioning of resources between the apparatus and one or more non-serving Node Bs, UL resources for a UE to send a signal for monitoring a radio link; and means for transmitting an indication of the UL resources.

In an aspect of the disclosure, an apparatus for wireless communications is provided. The apparatus generally includes at least one processor and a transmitter. The at least one processor is generally configured to determine, based on cooperative partitioning of resources between the apparatus and one or more non-serving Node Bs, UL resources for a UE to send a signal for monitoring a radio link. The transmitter is typically configured to transmit an indication of the UL resources.

In an aspect of the disclosure, a computer-program product for wireless communications is provided. The computer-program product generally includes a computer-readable medium having code for determining, based on cooperative partitioning of resources between a serving Node B and one or more non-serving Node Bs, UL resources for a UE to send a signal for monitoring a radio link; and transmitting an indication of the UL resources.

In an aspect of the disclosure, a method for wireless communications. The method generally includes receiving an indication of UL resources for a UE to send a signal for monitoring a radio link, wherein the UL resources are based on cooperative partitioning of resources between a serving Node B and one or more non-serving Node Bs; and transmitting the signal for monitoring the radio link according to the received indication of the UL resources.

In an aspect of the disclosure, an apparatus for wireless communications is provided. The apparatus generally includes means for receiving an indication of UL resources for the apparatus to send a signal for monitoring a radio link, wherein the UL resources are based on cooperative partitioning of resources between a serving Node B and one or more non-serving Node Bs; and means for transmitting the signal for monitoring the radio link according to the received indication of the UL resources.

In an aspect of the disclosure, an apparatus for wireless communications is provided. The apparatus generally includes a receiver and a transmitter. The receiver is typically configured to receive an indication of UL resources for the apparatus to send a signal for monitoring a radio link, wherein the UL resources are based on cooperative partitioning of resources between a serving Node B and one or more non-serving Node Bs. The transmitter is generally configured to transmit the signal for monitoring the radio link according to the received indication of the UL resources.

In an aspect of the disclosure, a computer-program product for wireless communications is provided. The computer-program product generally includes a computer-readable medium having code for receiving an indication of UL resources for a UE to send a signal for monitoring a radio link, wherein the UL resources are based on cooperative partitioning of resources between a serving Node B and one or more non-serving Node Bs; and transmitting the signal for monitoring the radio link according to the received indication of the UL resources.

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a Node B in communication with a user equipment device (UE) in a wireless communications network in accordance with certain aspects of the present disclosure.

FIG. 4 illustrates an example heterogeneous network (HetNet) in accordance with certain aspects of the present disclosure.

FIG. 5 illustrates example resource partitioning in a heterogeneous network in accordance with certain aspects of the present disclosure.

FIG. 6 illustrates example cooperative partitioning of subframes in a heterogeneous network in accordance with certain aspects of the present disclosure.

FIG. 7 is a flow diagram conceptually illustrating example operations for reducing interference when monitoring an uplink channel through cooperative partitioning of resources between a serving Node B and one or more non-serving Node Bs, from the perspective of the serving Node B, in accordance with certain aspects of the present disclosure.

FIG. 8 is a flow diagram conceptually illustrating example operations for reducing interference when monitoring an uplink channel through cooperative partitioning of resources between a serving Node B and one or more non-serving Node Bs, from the perspective of a UE, in accordance with certain aspects of the present disclosure.

FIG. 9 illustrates example resource partitioning with two protected subframes, one for channel quality indicator (CQI) reporting and the other for a sounding reference signal (SRS), in accordance with certain aspects of the present disclosure.

FIG. 10 illustrates example resource partitioning with interleaving of CQI reporting and the SRS in accordance with certain aspects of the present disclosure.

FIG. 11 illustrates example resource partitioning where the CQI is dropped rather than the SRS for collisions therebetween, in accordance with certain aspects of the present disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

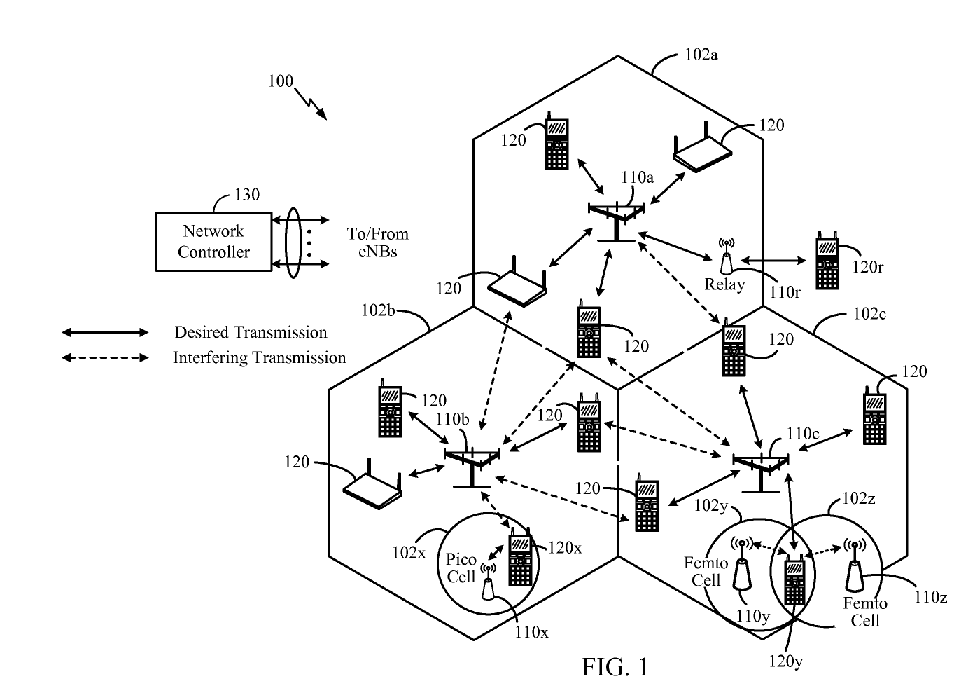

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

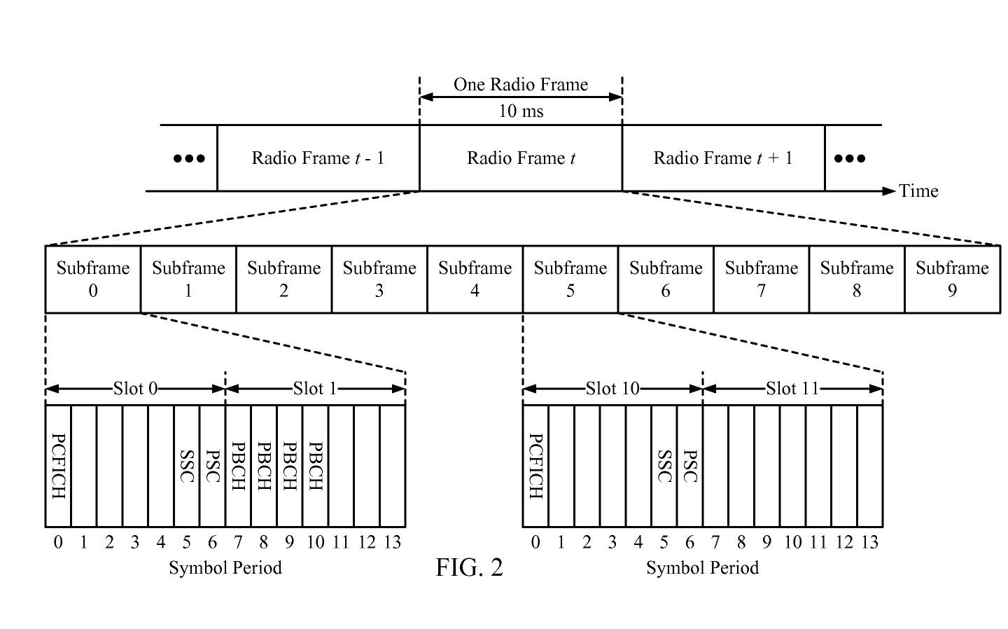

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

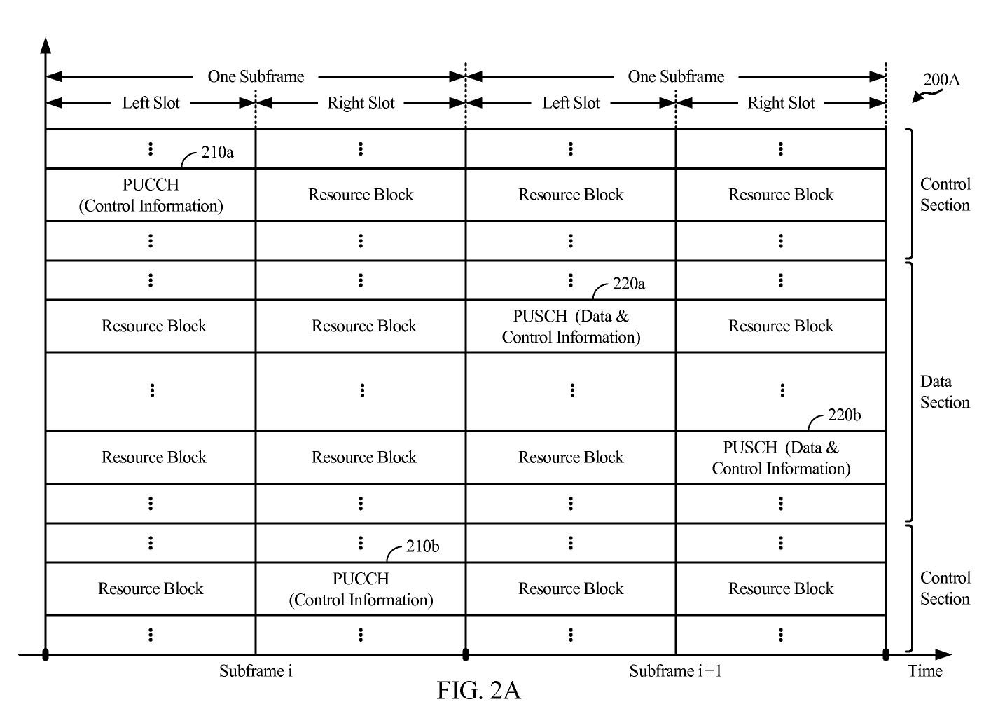

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

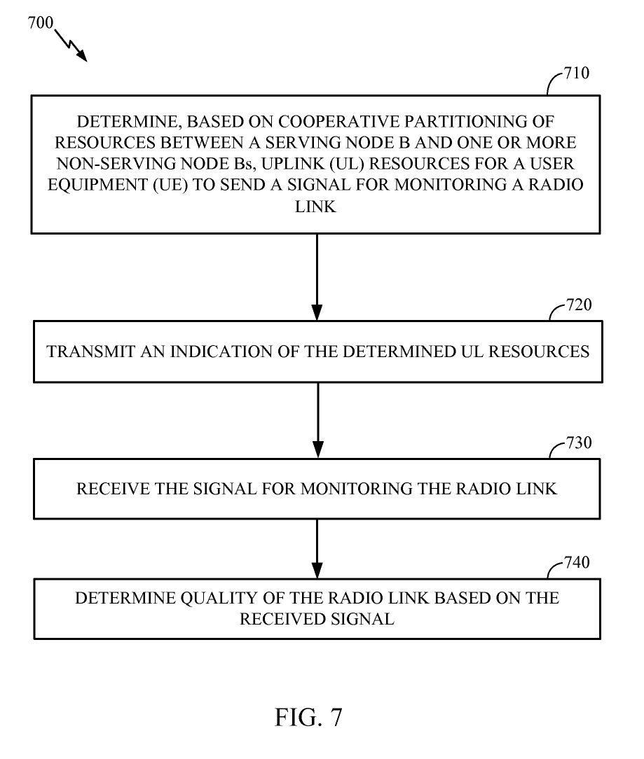

The controllers/processors 340 and 380 may direct the operation at the eNB 110 and the UE 120, respectively. The controller/processor 340, receive processor 338, and/or other processors and modules at the eNB 110 may perform or direct operations 800 in FIG. 8 and/or other processes for the techniques described herein. The memories 342 and 382 may store data and program codes for the eNB 110 and the UE 120, respectively. A scheduler 344 may schedule UEs for data transmission on the downlink and/or uplink.

### Example Resource Partitioning

According to certain aspects of the present disclosure, when a network supports enhanced inter-cell interference coordination (eICIC), the base stations may negotiate with each other to coordinate resources in order to reduce or eliminate interference by the interfering cell giving up part of its resources. In accordance with this interference coordination, a UE may be able to access a serving cell even with severe interference by using resources yielded by the interfering cell.

For example, a femto cell with a closed access mode (i.e., in which only a member femto UE can access the cell) in the coverage area of an open macro cell may be able to create a “coverage hole” (in the femto cell's coverage area) for a macro cell by yielding resources and effectively removing interference. By negotiating for a femto cell to yield resources, the macro UE under the femto cell coverage area may still be able to access the UE's serving macro cell using these yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

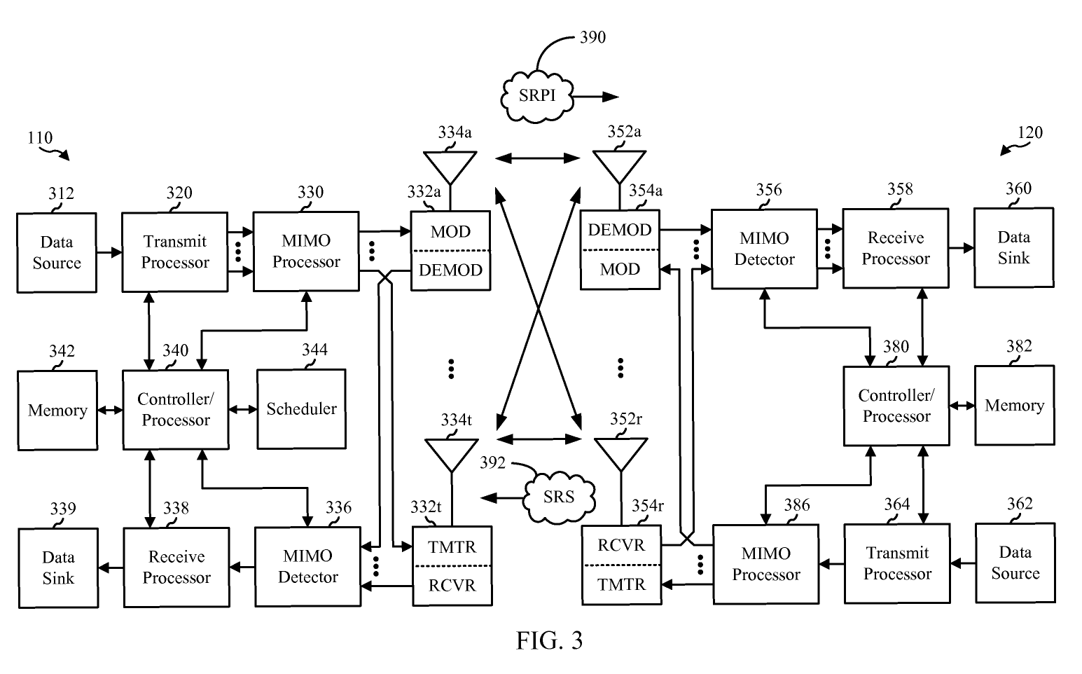

FIG. 4 illustrates an example scenario where eICIC may allow a macro UE 120y supporting eICIC (e.g., a Rel-10 macro UE as shown in FIG. 4) to access the macro cell 110c even when the macro UE 120y is experiencing severe interference from the femto cell y, as illustrated by the solid radio link 402. A legacy macro UE 120u (e.g., a Rel-8 macro UE as shown in FIG. 4) may not be able to access the macro cell 110c under severe interference from the femto cell 110y, as illustrated by the broken radio link 404. A femto UE 120v (e.g., a Rel-8 femto UE as shown in FIG. 4) may access the femto cell 110y without any interference problems from the macro cell 110c.

According to certain aspects, networks may support eICIC, where there may be different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be sent to a UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For communications via the downlink (e.g., from a cell node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index:

Index_{SRPI}_{_{—}}_{DL}=(SFN*10+subframe number)mod 8

For the uplink, the SRPI mapping may be shifted, for example, by 4 ms. Thus, an example for the uplink may be:

Index_{SRPI}_{_{—}}_{UL}=(SFN*10+subframe number+4)mod 8

SRPI may use the following three values for each entry:
U (Use): this value indicates the subframe has been cleaned up from the dominant interference to be used by this cell (i.e., the main interfering cells do not use this subframe);
N (No Use): this value indicates the subframe shall not be used; and
X (Unknown): this value indicates the subframe is not statically partitioned.

Details of resource usage negotiation between base stations are not known to the UE.

Another possible set of parameters for SRPI may be the following:
U (Use): this value indicates the subframe has been cleaned up from the dominant interference to be used by this cell (i.e., the main interfering cells do not use this subframe);
N (No Use): this value indicates the subframe shall not be used;
X (Unknown): this value indicates the subframe is not statically partitioned (and details of resource usage negotiation between base stations are not known to the UE); and
C (Common): this value may indicate all cells may use this subframe without resource partitioning. This subframe may be subject to interference, so that the base station may choose to use this subframe only for a UE that is not experiencing severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g. macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identities (PCIs).

ARPI may represent further resource partitioning information with the detailed information for the ‘X’ subframes in SRPI. As noted above, detailed information for the ‘X’ subframes is typically only known to the base stations, and a UE does not know it.

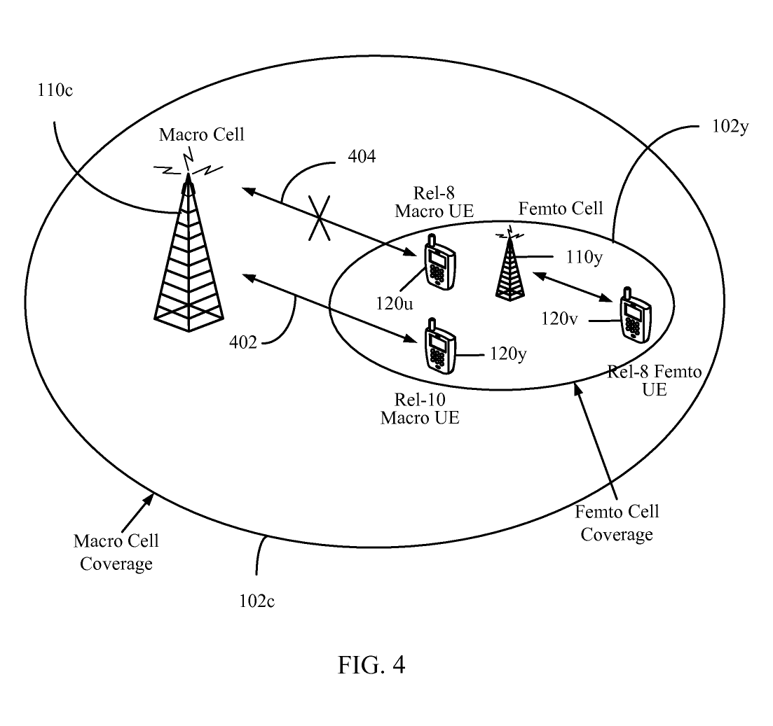

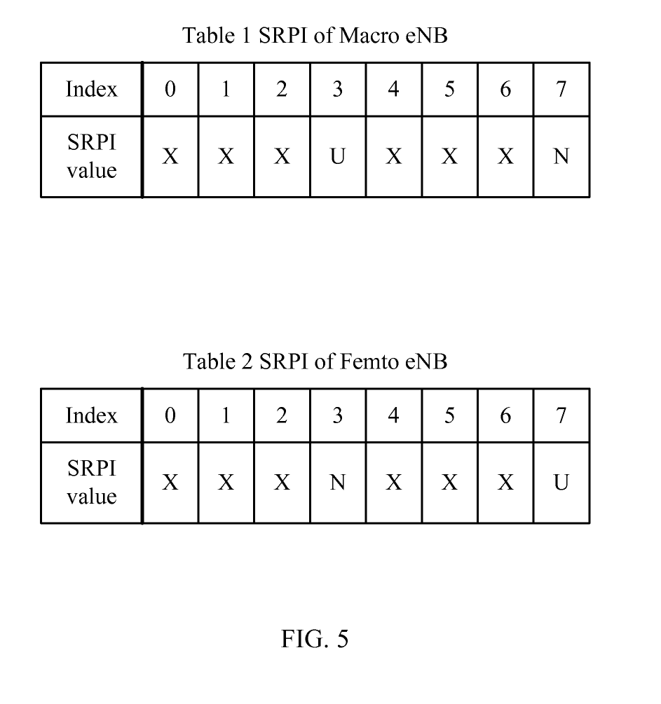

FIGS. 5 and 6 illustrate examples of SRPI assignment in the scenario with macro and femto cells. A U, N, X, or C subframe is a subframe corresponding to a U, N, X, or C SRPI assignment.

### Example SRS in HetNet with TDM Partitioning

Radio Link Monitoring (RLM) is a mechanism that allows a base station to monitor the quality of the uplink channel of the served UE, based on measurements from the UE transmissions. If the radio link quality (i.e., the quality of the uplink channel) falls below a certain threshold, a Radio Problem condition may be declared. In a heterogeneous network (HetNet) scenario, the uplink transmissions of the UE may be subject to severe interference from neighbor cells, which may cause problems for the operation of the RLM.

Time division multiplexing (TDM) partitioning is one of the inter-cell interference coordination (ICIC) mechanisms considered for HetNet ICIC in co-channel deployment. For example, in subframes that are pre-allocated to a serving eNB for downlink (DL) transmissions, neighbor eNBs do not transmit, thereby reducing interference experienced by the served UEs. TDM partitioning functions similarly for uplink (UL) transmissions. Some subframes may be statically allocated (e.g., U: protected, N: reserved), while others may be dynamically assigned as described above. For such aspects, there may be at least one statically assigned U subframe per resource partitioning period (e.g., period=8 ms). Most likely, there is only one statically assigned U subframe per period.

Problems may occur in the UL when a macro UE enters a femto coverage area. A macro UE in femto coverage may jam the UL of femto UEs, unless TDM partitioning is enforced. TDM partitioning may be easily enforced for uplink data transmission on PUSCH (e.g., by means of smart UL grants by the eNB scheduler). However, TDM partitioning is more difficult for uplink control information (channel quality indicator/precoding matrix indicator (CQI/PMI), rank indicator (RI), scheduling request (SR), and acknowledge/not acknowledged (ACK/NACK)) and sounding reference signals (SRSs).

Although in this disclosure, examples of interference coordination between a femto serving Node B and a macro non-serving Node B are illustrated and described, interference coordination described herein may occur between other types of Node Bs or base stations, such as between a femto Node B and a pico Node B, another femto Node B, a relay, a WiFi access terminal, or a Bluetooth transceiver.

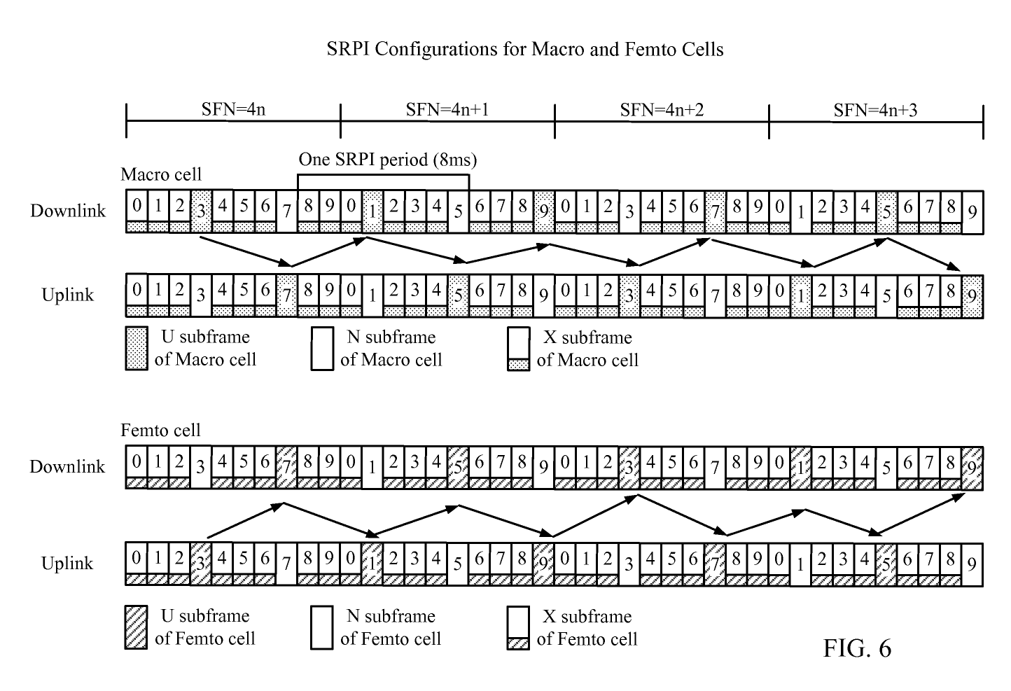

FIG. 7 is a flow diagram illustrating example operations 700 for reducing interference when monitoring an uplink channel through cooperative partitioning of resources between a serving Node B and one or more non-serving Node Bs, from the perspective of the serving Node B. The operations 700 may be executed, for example, at the processor(s) 340, 320, and/or 338 of the eNB 110 from FIG. 3. The operations 700 may begin at 710 by determining, based on cooperative partitioning of resources between a serving Node B and one or more non-serving Node Bs, UL resources for a UE to send a signal for monitoring a radio link (e.g., an SRS). At 720, the serving Node B may transmit an indication of the determined UL resources. For example, FIG. 3 illustrates an eNB 110 transmitting the SRPI 390 to a UE 120 as an indication of the determined UL resources. Returning to FIG. 7, the signal for monitoring the radio link may be received by the serving Node B at 730. For example, FIG. 3 illustrates the UE 120 transmitting an SRS 392 to the eNB 110 as a signal for monitoring the radio link. At 740 in FIG. 7, the serving Node B may determine quality of the radio link based on the received signal.

FIG. 8 is a flow diagram illustrating example operations 800 for reducing interference when monitoring an uplink channel through cooperative partitioning of resources between a serving Node B and one or more non-serving Node Bs, from the perspective of a user equipment (UE). The operations 800 may be executed, for example, at the processor(s) 380, 358, and/or 364 of the UE 120 from FIG. 3. The operations 800 may begin at 810 by receiving an indication of UL resources for the UE to send a signal for monitoring a radio link (e.g., an SRS), wherein the UL resources are based on cooperative partitioning of resources between a serving Node B and one or more non-serving Node Bs. At 820, the UE may transmit the signal for monitoring the radio link according to the received indication of the UL resources.

In the present disclosure, the primary focus is on SRS and scenarios involving a UL aggressor/victim (e.g., a macro UE in femto coverage, jamming femto UEs). Currently, smaller values of SRS periodicity are not compatible with TDM partitioning (namely, minimum SRS period integer multiple of 8 ms is currently 40 ms). SRS periodicities of 8 ms or 16 ms are not currently supported, although such periodicities may be defined. Hence, one cannot ensure that SRS is always transmitted in protected subframes (i.e., U subframes), unless a low-rate reporting (e.g., 40 ms) is used.

### SRS Transmitted in U Subframes

Regardless, ensuring that an SRS is always transmitted in U subframes is not a complete solution either. According to the LTE specification, when the CQI (in PUCCH) and an SRS scheduled to be transmitted by the same UE collide, the SRS is dropped. Like the SRS, CQI reporting may be periodic and may most likely be based on an 8 ms reporting periodicity, too, in order to employ U subframes. Assuming only one U subframe is available per period, the SRS would then always be dropped.

Accordingly what is needed are techniques and apparatus for using the SRS to monitor a UE's UL, but avoiding interference from other UEs being served by other eNBs and/or collisions with other uplink signals, such as CQI.

### Option 1

### Two Static U Subframes

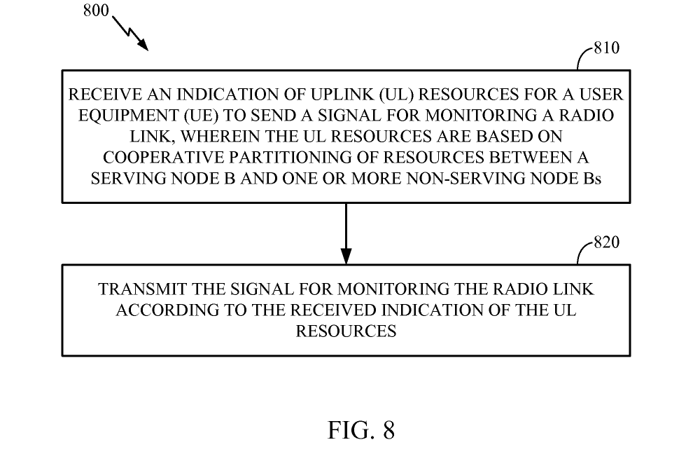

In the first option, if at least two static U subframes are available, one may be assigned to CQI reporting, and the other one may be assigned to an SRS. Rules for defining which U subframe to use for which purpose may most likely be defined. For certain aspects, the “first” U subframe of the period may be assigned for the CQI, and a “second” U subframe may be assigned for the SRS as illustrated in FIG. 9, or vice versa.

### Option 2

### Interleaving

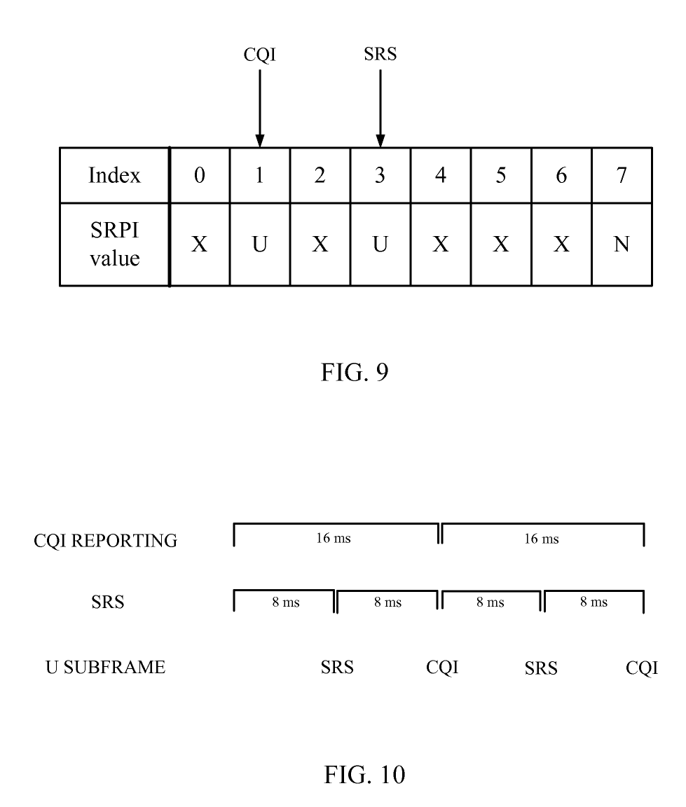

In the second option, CQI reporting periodicity may be a multiple of (e.g., twice) the SRS periodicity. For example, if the periodicity of the SRS is 8 ms, then the CQI reporting periodicity may be 16 ms. In this particular example with doubled periodicity, this effectively boils down to alternating between CQI reporting and SRS transmission, as depicted in FIG. 10.

### Option 3

### Drop CQI Rather than SRS when Collision Occurs

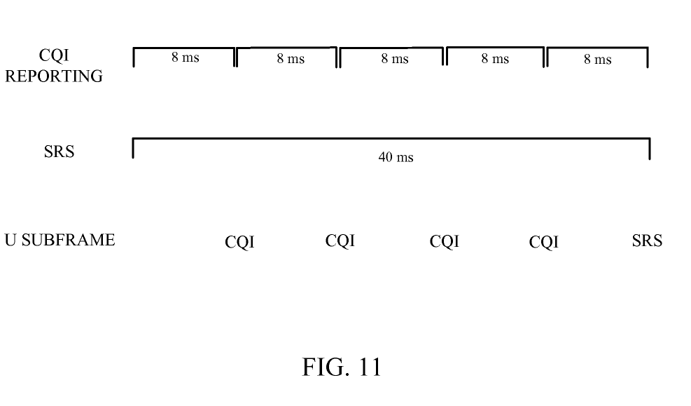

For the third option, the dropping rules may be changed such that the CQI is dropped rather than the SRS when a collision occurs. This may work since the SRS may tolerate lower rate transmission than CQI reporting. Hence, the SRS may be configured with a higher periodicity (e.g., 40 ms), and whenever an SRS is scheduled to be transmitted on a U subframe, the CQI is dropped accordingly as shown in FIG. 11.

With this option, sometimes outdated CQI information may be used because the latest CQI report has been dropped in favor of the SRS. The eNB scheduler may take this into account while making scheduling decisions (e.g., which UEs to schedule and/or the modulation and coding schemes (MCSs) to use).

### Option 4

### Allow Joint Transmission of SRS and CQI in PUCCH

This option may also involve changing the dropping rules, namely by allowing joint transmission of the CQI (in PUCCH) and the SRS. In other words, rather than dropping the SRS (or the CQI, as in Option 3 above) when the SRS and CQI collide, a suitable multiplexing rule may be defined in an effort to ensure both may be transmitted. For example, a suitable shortened PUCCH format (for use by the CQI) may be defined involving puncturing the last SC-FDMA symbol when the SRS is transmitted. The PUCCH coding gain may be reduced due to this puncturing.

### Option 5

### Carry CQI Reporting in PUSCH

As a fifth option, for those U subframes where a CQI/SRS collision is expected, the eNB may send a dummy uplink (UL) grant to the corresponding UE, even if this UE has no data in its UL buffer. This grant may involve minimal resource allocation to avoid any waste. The UE may then be expected to send the PUSCH rather than the PUCCH in the UL subframe corresponding to the UL grant, and UL control information (UCI) may be multiplexed within the PUSCH. The PUSCH and SRS can coexist (e.g., by puncturing the last SC-FDMA symbol). For certain aspects, the PUSCH may be rate matched around the last SC-FDMA symbol.

Being internal to the eNB, this option does not entail changes to the current LTE specification. However, scalability with the number of UEs may be an issue.

Similarly, an aperiodic CQI report may be requested (e.g., through a suitable physical DL control channel (PDCCH) DL control information (DCI)) for those U subframes where a CQI/SRS collision is expected. An aperiodic CQI report has priority over a periodic CQI report. In this case, PUSCH (rather than PUCCH) may be used for the aperiodic CQI report, and the SRS may be transmitted in the same subframe.

### SRS Transmitted in Non-U Subframes

For certain aspects, the SRS may be transmitted in non-U subframes, as well. In such aspects, the CQI and SRS may be configured either (1) to never collide (e.g., the same periodicity with different subframe offsets, or suitably selected different periodicities, such as a CQI reporting periodicity of 8 ms and an SRS periodicity of 10 ms with an odd offset with respect to CQI reporting), or (2) to sometimes collide (e.g., same as above, but the SRS has an even offset with respect to CQI reporting). In the first case, the SRS may never be transmitted on statically assigned U subframes. This might entail issues at the eNB (depending on adaptive partitioning) because the SRS may always be received during jammed subframes. When the SRS is transmitted on a non-U subframe, the SRS may jam a victim UE's UL. One example of this is an SRS transmitted by a macro UE (in a femto coverage area) in the macro UE's N subframe, which coincides with a femto's U subframe.

Several solutions to this problem may be possible and are provided below.

### Option A

### Semi-Statically Allocated or Common Subframes for Protection

In this first non-U-subframes option, a set of semi-statically allocated protected or common subframes (for UL only) may be defined, in addition to the standard statically allocated U subframes. SRSs may be transmitted on these subframes and may never collide with CQI from the same UE. To ensure against collision, an SRS periodicity of 8 ms may be used, equal to the CQI reporting periodicity of 8 ms. Such semi-statically allocated or common subframes may most likely be suitably taken into account by the backhaul resource negotiation algorithm.

### Option B

### SRS Subband Partitioning Among Power Classes

In this second non-U-subframes option, frequency resources used for SRS transmission may depend on the power class of the UE's anchor eNB (i.e., serving eNB). The network may ensure that disjoint subbands are used by SRSs from UEs belonging to different power classes.

Besides the SRS, the PUCCH and/or PUSCH of victim UEs may most likely be protected, too.

### Option C

### Use Shortened Format

For this third non-U-subframes option, all UEs which are victims in the UL (e.g., femto UEs) may always assume they transmit an SRS, even when these UEs do not. Hence, the last SC-FDMA symbol may be unused whenever possible (e.g., rate matching of the PUSCH content by going around last symbol). In other words, a subset of subframes, common among all nodes and independent of the interlace partitioning (e.g., the U and N subframes) may be selected, for which the last SC-FDMA symbol is reserved and may be used for the SRS only. Depending on power class and possibly other parameters (e.g., cell-specific SRS-related subframe configuration parameters), each UE is instructed by a corresponding eNB to send the SRS on a subset of this subset of subframes, with the goal of avoiding SRS-to-SRS collision between victim and jamming UEs. There may be overhead due to constant loss of one symbol, but with this option, no collisions between the SRS and the PUSCH of other UEs can happen.

### Option D

### Tolerate Jamming

In order to reduce the impact of jamming (due to severe interference), a small SRS bandwidth may be used in this fourth non-U-subframes option. For example, this narrow bandwidth may comprise only 4 resource blocks (RBs). In this manner, many UEs' SRSs may share the same subframe or other time resources. Since only a few RBs are used by the SRS, collision probability is small. However, this option may not scale well with the number of UEs since the probability of a collision increases.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for transmitting or means for sending may comprise a transmitter, a modulator 332, and/or an antenna 334 of the eNB 110 or a transmitter, a modulator 354, and/or an antenna 352 of the UE 120 shown in FIG. 3. Means for receiving may comprise a receiver, a demodulator 332, and/or an antenna 334 of the eNB 110 or a receiver, a demodulator 354, and/or an antenna 352 of the UE 120 depicted in FIG. 3. Means for processing, means for determining, means for dropping, means for scheduling, means for reserving, and/or means for requesting may comprise a processing system, which may include at least one processor, such as the transmit processor 320, the receive processor 338, and/or the controller/processor 340 of the eNB 110 illustrated in FIG. 3.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications, comprising:
determining, based on cooperative partitioning of resources between a serving Node B and one or more non-serving Node Bs, uplink (UL) resources for a user equipment (UE) to send a signal for monitoring a radio link; and
transmitting an indication of the determined UL resources.

2. The method of claim 1, wherein the signal for monitoring the radio link comprises a sounding reference signal (SRS).

3. The method of claim 2, wherein the cooperative partitioning yields one or more subframes in a resource partitioning period that are protected from interference.

4. The method of claim 3, wherein a first one of the protected subframes in the resource partitioning period is allocated for a channel quality indicator (CQI) and a second one of the protected subframes in the resource partitioning period is allocated for the SRS.

5. The method of claim 3, wherein a periodicity of a channel quality indicator (CQI) is double a periodicity of the SRS.

6. The method of claim 3, further comprising receiving the SRS during one of the protected subframes.

7. The method of claim 6, further comprising:
receiving a channel quality indicator (CQI) during the same one of the protected subframes; and
processing both the SRS and the CQI.

8. The method of claim 7, wherein the CQI uses a shortened physical uplink control channel (PUCCH) format.

9. The method of claim 3, further comprising:
sending a dummy uplink (UL) grant corresponding to one of the protected subframes where a collision between the SRS and a channel quality indicator (CQI) is expected;
receiving the SRS during the one of the protected subframes;
receiving a channel quality indicator (CQI) within a physical uplink shared channel (PUSCH) during the same one of the protected subframes; and
processing both the SRS and the CQI.

10. The method of claim 3, further comprising:
requesting an aperiodic channel quality indicator (CQI) report;
receiving the SRS during one of the protected subframes;
receiving a CQI within a physical uplink shared channel (PUSCH) during the same one of the protected subframes; and
processing both the SRS and the CQI.

11. The method of claim 10, wherein requesting the aperiodic CQI report comprises requesting the aperiodic CQI report for the one of the protected subframes where a collision between the SRS and a periodic CQI is expected.

12. The method of claim 3, further comprising receiving the SRS during one of the subframes in the resource partitioning period that is not statically protected.

13. The method of claim 12, wherein the cooperative partitioning yields at least one subframe in the resource partitioning period that is semi-statically protected from interference or common and wherein the SRS is received during the at least one subframe.

14. The method of claim 13, wherein a periodicity of a channel quality indicator (CQI) is equal to a periodicity of the SRS.

15. The method of claim 12, wherein the cooperative partitioning allocates frequency resources for transmission of the SRS based on a power class of the serving Node B.

16. The method of claim 12, wherein the cooperative partitioning allocates a first narrow bandwidth for transmission of the SRS by the UE.

17. The method of claim 16, wherein the cooperative partitioning allocates a second narrow bandwidth, different from the first narrow bandwidth, for transmission of another SRS by another UE.

18. The method of claim 12, further comprising reserving, for transmission of the SRS only and independent of the cooperative partitioning, the last single-carrier frequency division multiple access (SC-FDMA) symbol of the one of the subframes that is not statically protected.

19. The method of claim 1, wherein the serving Node B comprises a femto base station and the one or more non-serving Node Bs comprise at least one of a macro base station, a pico base station, another femto base station, a relay, a WiFi access terminal, or a Bluetooth transceiver.

20. An apparatus for wireless communications, comprising:
means for determining, based on cooperative partitioning of resources between the apparatus and one or more non-serving Node Bs, uplink (UL) resources for a user equipment (UE) to send a signal for monitoring a radio link; and
means for transmitting an indication of the determined UL resources.

21. The apparatus of claim 20, wherein the signal for monitoring the radio link comprises a sounding reference signal (SRS).

22. The apparatus of claim 21, wherein the cooperative partitioning yields one or more subframes in a resource partitioning period that are protected from interference.

23. The apparatus of claim 22, wherein a first one of the protected subframes in the resource partitioning period is allocated for a channel quality indicator (CQI) and a second one of the protected subframes in the resource partitioning period is allocated for the SRS.

24. The apparatus of claim 22, wherein a periodicity of a channel quality indicator (CQI) is double a periodicity of the SRS.

25. The apparatus of claim 22, further comprising means for receiving the SRS during one of the protected subframes.

26. The apparatus of claim 25, further comprising:
means for receiving a channel quality indicator (CQI) during the same one of the protected subframes; and
means for processing both the SRS and the CQI.

27. The apparatus of claim 26, wherein the CQI uses a shortened physical uplink control channel (PUCCH) format.

28. The apparatus of claim 22, further comprising:
means for sending a dummy uplink (UL) grant corresponding to one of the protected subframes where a collision between the SRS and a channel quality indicator (CQI) is expected;
means for receiving the SRS during the one of the protected subframes;
means for receiving a channel quality indicator (CQI) within a physical uplink shared channel (PUSCH) during the same one of the protected subframes; and
means for processing both the SRS and the CQI.

29. The apparatus of claim 22, further comprising:
means for requesting an aperiodic channel quality indicator (CQI) report;
means for receiving the SRS during one of the protected subframes;
means for receiving a CQI within a physical uplink shared channel (PUSCH) during the same one of the protected subframes; and
means for processing both the SRS and the CQI.

30. The apparatus of claim 29, wherein the means for requesting the aperiodic CQI report is configured to request the aperiodic CQI report for the one of the protected subframes where a collision between the SRS and a periodic CQI is expected.

31. The apparatus of claim 22, further comprising means for receiving the SRS during one of the subframes in the resource partitioning period that is not statically protected.

32. The apparatus of claim 31, wherein the cooperative partitioning yields at least one subframe in the resource partitioning period that is semi-statically protected from interference or common and wherein the SRS is received during the at least one subframe.

33. The apparatus of claim 32, wherein a periodicity of a channel quality indicator (CQI) is equal to a periodicity of the SRS.

34. The apparatus of claim 31, wherein the cooperative partitioning allocates frequency resources for transmission of the SRS based on a power class of the apparatus.

35. The apparatus of claim 31, wherein the cooperative partitioning allocates a first narrow bandwidth for transmission of the SRS by the UE.

36. The apparatus of claim 35, wherein the cooperative partitioning allocates a second narrow bandwidth, different from the first narrow bandwidth, for transmission of another SRS by another UE.

37. The apparatus of claim 31, further comprising means for reserving, for transmission of the SRS only and independent of the cooperative partitioning, the last single-carrier frequency division multiple access (SC-FDMA) symbol of the one of the subframes that is not statically protected.

38. The apparatus of claim 20, wherein the apparatus comprises a femto base station and the one or more non-serving Node Bs comprise at least one of a macro base station, a pico base station, another femto base station, a relay, a WiFi access terminal, or a Bluetooth transceiver.

39. An apparatus for wireless communications, comprising:
at least one processor configured to determine, based on cooperative partitioning of resources between the apparatus and one or more non-serving Node Bs, uplink (UL) resources for a user equipment (UE) to send a signal for monitoring a radio link; and
a transmitter configured to transmit an indication of the determined UL resources.

40. The apparatus of claim 39, wherein the signal for monitoring the radio link comprises a sounding reference signal (SRS).

41. The apparatus of claim 40, wherein the cooperative partitioning yields one or more subframes in a resource partitioning period that are protected from interference.

42. The apparatus of claim 41, wherein a first one of the protected subframes in the resource partitioning period is allocated for a channel quality indicator (CQI) and a second one of the protected subframes in the resource partitioning period is allocated for the SRS.

43. The apparatus of claim 41, wherein a periodicity of a channel quality indicator (CQI) is double a periodicity of the SRS.

44. The apparatus of claim 41, further comprising a receiver configured to receive the SRS during one of the protected subframes.

45. The apparatus of claim 44, wherein the receiver is configured to receive a channel quality indicator (CQI) during the same one of the protected subframes and wherein the at least one processor is configured to process both the SRS and the CQI.

46. The apparatus of claim 45, wherein the CQI uses a shortened physical uplink control channel (PUCCH) format.

47. The apparatus of claim 41, further comprising a receiver, wherein the transmitter is configured to send a dummy uplink (UL) grant corresponding to one of the protected subframes where a collision between the SRS and a channel quality indicator (CQI) is expected, wherein the receiver is configured to receive the SRS during the one of the protected subframes and to receive a channel quality indicator (CQI) within a physical uplink shared channel (PUSCH) during the same one of the protected subframes, and wherein the at least one processor is configured to process both the SRS and the CQI.

48. The apparatus of claim 41, further comprising a receiver, wherein the at least one processor is configured to request an aperiodic channel quality indicator (CQI) report, wherein the receiver is configured to receive the SRS during one of the protected subframes and to receive a CQI within a physical uplink shared channel (PUSCH) during the same one of the protected subframes, and wherein the at least one processor is configured to process both the SRS and the CQI.

49. The apparatus of claim 48, wherein the at least one processor is configured to request the aperiodic CQI report for the one of the protected subframes where a collision between the SRS and a periodic CQI is expected.

50. The apparatus of claim 41, further comprising a receiver configured to receive the SRS during one of the subframes in the resource partitioning period that is not statically protected.

51. The apparatus of claim 50, wherein the cooperative partitioning yields at least one subframe in the resource partitioning period that is semi-statically protected from interference or common and wherein the SRS is received during the at least one subframe.

52. The apparatus of claim 51, wherein a periodicity of a channel quality indicator (CQI) is equal to a periodicity of the SRS.

53. The apparatus of claim 50, wherein the cooperative partitioning allocates frequency resources for transmission of the SRS based on a power class of the apparatus.

54. The apparatus of claim 50, wherein the cooperative partitioning allocates a first narrow bandwidth for transmission of the SRS by the UE.

55. The apparatus of claim 54, wherein the cooperative partitioning allocates a second narrow bandwidth, different from the first narrow bandwidth, for transmission of another SRS by another UE.

56. The apparatus of claim 50, wherein the at least one processor is configured to reserve, for transmission of the SRS only and independent of the cooperative partitioning, the last single-carrier frequency division multiple access (SC-FDMA) symbol of the one of the subframes that is not statically protected.

57. The apparatus of claim 39, wherein the apparatus comprises a femto base station and the one or more non-serving Node Bs comprise at least one of a macro base station, a pico base station, another femto base station, a relay, a WiFi access terminal, or a Bluetooth transceiver.

58. A computer-program product for wireless communications, the computer-program product comprising:
a computer-readable medium having code for:
determining, based on cooperative partitioning of resources between a serving Node B and one or more non-serving Node Bs, uplink (UL) resources for a user equipment (UE) to send a signal for monitoring a radio link; and
transmitting an indication of the determined UL resources.

59. A method for wireless communications, comprising:
receiving an indication of uplink (UL) resources for a user equipment (UE) to send a signal for monitoring a radio link, wherein the UL resources are based on cooperative partitioning of resources between a serving Node B and one or more non-serving Node Bs; and
transmitting the signal for monitoring the radio link according to the received indication of the UL resources.

60. The method of claim 59, wherein the signal for monitoring the radio link comprises a sounding reference signal (SRS).

61. The method of claim 60, wherein the cooperative partitioning yields one or more subframes in a resource partitioning period that are protected from interference.

62. The method of claim 61, wherein a first one of the protected subframes in the resource partitioning period is allocated for a channel quality indicator (CQI) and a second one of the protected subframes in the resource partitioning period is allocated for the SRS.

63. The method of claim 61, wherein a periodicity of a channel quality indicator (CQI) is double a periodicity of the SRS.

64. The method of claim 61, further comprising:
scheduling the SRS for transmission during one of the protected subframes;
scheduling a channel quality indicator (CQI) during the same one of the protected subframes;
dropping the CQI; and
transmitting the SRS during the one of the protected subframes.

65. The method of claim 61, further comprising:
transmitting the SRS during one of the protected subframes; and
transmitting a channel quality indicator (CQI) during the same one of the protected subframes.

66. The method of claim 65, wherein the CQI uses a shortened physical uplink control channel (PUCCH) format.

67. The method of claim 61, further comprising:
receiving a dummy uplink (UL) grant corresponding to one of the protected subframes where a collision between the SRS and a channel quality indicator (CQI) is expected;
transmitting the SRS during the one of the protected subframes; and
transmitting a channel quality indicator (CQI) within a physical uplink shared channel (PUSCH) during the same one of the protected subframes.

68. The method of claim 61, further comprising:
receiving a request for an aperiodic channel quality indicator (CQI) report;
transmitting the SRS during one of the protected subframes;
transmitting a CQI within a physical uplink shared channel (PUSCH) during the same one of the protected subframes.

69. The method of claim 68, wherein receiving the request comprises receiving the request for the aperiodic CQI report for the one of the protected subframes where a collision between the SRS and a periodic CQI is expected.

70. The method of claim 61, further comprising transmitting the SRS during one of the subframes in the resource partitioning period that is not statically protected.

71. The method of claim 70, wherein the cooperative partitioning yields at least one subframe in the resource partitioning period that is common or semi-statically protected from interference and wherein the SRS is transmitted during the at least one subframe.

72. The method of claim 71, wherein a periodicity of a channel quality indicator (CQI) is equal to a periodicity of the SRS.

73. The method of claim 70, wherein the cooperative partitioning allocates frequency resources for transmission of the SRS based on a power class of the serving Node B.

74. The method of claim 70, wherein the cooperative partitioning allocates a narrow bandwidth for transmission of the SRS by the UE.

75. The method of claim 70, wherein the last single-carrier frequency division multiple access (SC-FDMA) symbol of the one of the subframes that is not statically protected is reserved for transmission of the SRS only, independent of the cooperative partitioning.

76. An apparatus for wireless communications, comprising:
means for receiving an indication of uplink (UL) resources for the apparatus to send a signal for monitoring a radio link, wherein the UL resources are based on cooperative partitioning of resources between a serving Node B and one or more non-serving Node Bs; and
means for transmitting the signal for monitoring the radio link according to the received indication of the UL resources.

77. The apparatus of claim 76, wherein the signal for monitoring the radio link comprises a sounding reference signal (SRS).

78. The apparatus of claim 77, wherein the cooperative partitioning yields one or more subframes in a resource partitioning period that are protected from interference.

79. The apparatus of claim 78, wherein a first one of the protected subframes in the resource partitioning period is allocated for a channel quality indicator (CQI) and a second one of the protected subframes in the resource partitioning period is allocated for the SRS.

80. The apparatus of claim 78, wherein a periodicity of a channel quality indicator (CQI) is double a periodicity of the SRS.

81. The apparatus of claim 78, further comprising:
means for scheduling the SRS for transmission during one of the protected subframes;
means for scheduling a channel quality indicator (CQI) during the same one of the protected subframes; and
means for dropping the CQI; and
means for transmitting the SRS during the one of the protected subframes.

82. The apparatus of claim 78, further comprising:
means for transmitting the SRS during one of the protected subframes; and
means for transmitting a channel quality indicator (CQI) during the same one of the protected subframes.

83. The apparatus of claim 82, wherein the CQI uses a shortened physical uplink control channel (PUCCH) format.

84. The apparatus of claim 78, further comprising:
means for receiving a dummy uplink (UL) grant corresponding to one of the protected subframes where a collision between the SRS and a channel quality indicator (CQI) is expected;
means for transmitting the SRS during the one of the protected subframes; and
means for transmitting a channel quality indicator (CQI) within a physical uplink shared channel (PUSCH) during the same one of the protected subframes.

85. The apparatus of claim 78, further comprising:
means for receiving a request for an aperiodic channel quality indicator (CQI) report;
means for transmitting the SRS during one of the protected subframes;
means for transmitting a CQI within a physical uplink shared channel (PUSCH) during the same one of the protected subframes.

86. The apparatus of claim 85, wherein means for receiving the request is configured to receive the request for the aperiodic CQI report for the one of the protected subframes where a collision between the SRS and a periodic CQI is expected.

87. The apparatus of claim 78, further comprising means for transmitting the SRS during one of the subframes in the resource partitioning period that is not statically protected.

88. The apparatus of claim 87, wherein the cooperative partitioning yields at least one subframe in the resource partitioning period that is common or semi-statically protected from interference and wherein the SRS is transmitted during the at least one subframe.

89. The apparatus of claim 88, wherein a periodicity of a channel quality indicator (CQI) is equal to a periodicity of the SRS.

90. The apparatus of claim 87, wherein the cooperative partitioning allocates frequency resources for transmission of the SRS based on a power class of the serving Node B.

91. The apparatus of claim 87, wherein the cooperative partitioning allocates a narrow bandwidth for transmission of the SRS by the apparatus.

92. The apparatus of claim 87, wherein the last single-carrier frequency division multiple access (SC-FDMA) symbol of the one of the subframes that is not statically protected is reserved for transmission of the SRS only, independent of the cooperative partitioning.

93. An apparatus for wireless communications, comprising:
a receiver configured to receive an indication of uplink (UL) resources for the apparatus to send a signal for monitoring a radio link, wherein the UL resources are based on cooperative partitioning of resources between a serving Node B and one or more non-serving Node Bs; and
a transmitter configured to transmit the signal for monitoring the radio link according to the received indication of the UL resources.

94. The apparatus of claim 93, wherein the signal for monitoring the radio link comprises a sounding reference signal (SRS).

95. The apparatus of claim 94, wherein the cooperative partitioning yields one or more subframes in a resource partitioning period that are protected from interference.

96. The apparatus of claim 95, wherein a first one of the protected subframes in the resource partitioning period is allocated for a channel quality indicator (CQI) and a second one of the protected subframes in the resource partitioning period is allocated for the SRS.

97. The apparatus of claim 95, wherein a periodicity of a channel quality indicator (CQI) is double a periodicity of the SRS.

98. The apparatus of claim 95, further comprising at least one processor configured to:
schedule the SRS for transmission during one of the protected subframes;
schedule a channel quality indicator (CQI) during the same one of the protected subframes; and
drop the CQI, wherein the transmitter is configured to transmit the SRS during the one of the protected subframes.

99. The apparatus of claim 95, wherein the transmitter is configured to:
transmit the SRS during one of the protected subframes; and
transmit a channel quality indicator (CQI) during the same one of the protected subframes.

100. The apparatus of claim 99, wherein the CQI uses a shortened physical uplink control channel (PUCCH) format.

101. The apparatus of claim 95, wherein the receiver is configured to receive a dummy uplink (UL) grant corresponding to one of the protected subframes where a collision between the SRS and a channel quality indicator (CQI) is expected and wherein the transmitter is configured to:
transmit the SRS during the one of the protected subframes; and
transmit a channel quality indicator (CQI) within a physical uplink shared channel (PUSCH) during the same one of the protected subframes.

102. The apparatus of claim 95, wherein the receiver is configured to receive a request for an aperiodic channel quality indicator (CQI) report and wherein the transmitter is configured to:
transmit the SRS during one of the protected subframes; and
transmit a CQI within a physical uplink shared channel (PUSCH) during the same one of the protected subframes.

103. The method of claim 102, wherein the receiver is configured to receive the request for the aperiodic CQI report for the one of the protected subframes where a collision between the SRS and a periodic CQI is expected.

104. The apparatus of claim 95, wherein the transmitter is configured to transmit the SRS during one of the subframes in the resource partitioning period that is not statically protected.

105. The apparatus of claim 104, wherein the cooperative partitioning yields at least one subframe in the resource partitioning period that is common or semi-statically protected from interference and wherein the SRS is transmitted during the at least one subframe.

106. The apparatus of claim 105, wherein a periodicity of a channel quality indicator (CQI) is equal to a periodicity of the SRS.

107. The apparatus of claim 104, wherein the cooperative partitioning allocates frequency resources for transmission of the SRS based on a power class of the serving Node B.

108. The apparatus of claim 104, wherein the cooperative partitioning allocates a narrow bandwidth for transmission of the SRS by the apparatus.

109. The apparatus of claim 104, wherein the last single-carrier frequency division multiple access (SC-FDMA) symbol of the one of the subframes that is not statically protected is reserved for transmission of the SRS only, independent of the cooperative partitioning.

110. A computer-program product for wireless communications, the computer-program product comprising:
a computer-readable medium having code for:
receiving an indication of uplink (UL) resources for a user equipment (UE) to send a signal for monitoring a radio link, wherein the UL resources are based on cooperative partitioning of resources between a serving Node B and one or more non-serving Node Bs; and
transmitting the signal for monitoring the radio link according to the received indication of the UL resources.
